(19) United States
(12) Patent Application Publication
(10) Pub. No.: US 2025/0202900 A1
(43) Pub. Date: Jun. 19, 2025

(54) SYSTEMS AND METHODS FOR MARKING VIRTUAL IDENTITIES

(71) Applicant: Wells Fargo Bank, N.A., San Francisco, CA (US)

(72) Inventors: Jeff J. Stapleton, O'Fallon, MO (US); Manesh Saini, New York, NY (US); Krishnamraju V. Penmetcha, Fremont, CA (US); Sadie S Salim, Mill Valley, CA (US); Michael Knorr, Fairfield, CT (US); Brent Teitel, New York, NY (US)

(21) Appl. No.: 17/937,390

(22) Filed: Sep. 30, 2022

(51) Int. Cl. H04L 9/40

(52) U.S. Cl. CPC H04L 63/102; H04L 63/108

(57) ABSTRACT

Systems, apparatuses, methods, and computer program products are disclosed for constructing a marker to establish the identity of a digital avatar associated with an individual and linking the marker to various digital avatars representing other identities of the individual in virtual spaces. An example method includes linking the marker directly to digital avatars across virtual spaces. The example method further includes verifying identity activity of the digital avatars of the various other identities using the linked marker, and based on the verification of the identity activity, generate outputs.

### BACKGROUND

Virtual spaces (e.g., such as the metaverse) are computer-simulated places and/or environments with which users are able to interact via an interface (e.g., a computing device). As individuals spend more time within virtual spaces, these virtual spaces have become a valuable source for user-related information.

### BRIEF SUMMARY

An individual can have multiple virtual identities across multiple virtual spaces (e.g., via maintaining one or more accounts and/or profiles across these virtual spaces). While well-established mechanisms for identifying an individual in the real world exist (e.g., associating each individual with a global identification, such as a social security number, assigned to the individual), identifying the individual within virtual environments (e.g., the virtual spaces) can be more difficult. For example, a link between the individual (i.e., the physical person) and the individual's virtual identity (or identities) may not always be known to a third party (e.g., a friend, a family member, the individual's bank, etc.). As another example, said third parties may not always know how many virtual identities an individual owns. Such difficulties associated with being aware of an individual's virtual presence present challenges, concerns, and/or other restrictions (e.g., network security concerns, fraud concerns, etc.) for those interacting with the individual within these virtual spaces.

For example, an individual's virtual identity (e.g., digital avatar) may get hacked and be used by a malicious third-party actor to commit fraudulent activities without anyone (including the individual) being aware of such use of the individual's virtual identity. As another example, a malicious third-party actor may create a new virtual identity that is unknown to the individual while using the individual's private information (e.g., payment card information, etc.) with this new virtual identity. Or alternatively an avatar might get sold if the virtual space supports such transactions and the underlying identity of the party controlling the avatar has therefore changed. As yet another complication, an individual's virtual identity (e.g., digital avatar) might be visually similar to another's with minor differences (e.g., minor differences in hair style or color, clothes fashion or color, height, weight, weapons, etc.) and could change based on the individual's whim. Also, an individual's avatar name might be similar to another's avatar name. This puts anyone interacting with these virtual identities at risk of being involved in (e.g., as a victim, accomplice, etc.) the fraudulent activities committed by the malicious third-party actor.

As discussed above, virtual identities (e.g., digital avatars, virtual profiles, etc.) inherently include a layer of anonymity that may prevent or make it more difficult to determine who a person is interacting with within a virtual space (e.g., the metaverse). To address these challenges, an individual may mark (e.g., link a marker to) his or her virtual identities to assure others within the same virtual space that they are indeed interacting with the individual and not a misidentified third-party or malicious third-party actor posing as the individual. For example, an entity (e.g., a digital business avatar of a bank, etc.) initiated in a transaction with an unknown virtual identity may use the marker to verify that the unknown virtual identity belongs to a client/customer of the entity. As a result, the above-discussed issues (e.g., network security concerns, fraud concerns, etc.) can be avoided, and the use of such markers results in a direct improvement to virtual safety and virtual security technology.

Systems, apparatuses, methods, and computer program products are disclosed herein for linking a marker to one or more of an individual's virtual identities (e.g., digital avatars). Each individual may be provided with a unique marker, and each individual's marker may include patterns or other graphical representations similar to biometrics information markers in the real world (e.g., a unique identifier) used to uniquely identify the individual. More specifically, once an individual's digital avatar is marked with the individual's marker, other digital avatars (e.g., the above-discussed digital business avatar of a bank) within the virtual space may easily verify that the digital avatar is secured (e.g., the digital avatar is indeed controlled by the individual).

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 shows a block diagram illustrating a system in accordance with an embodiment.

FIG. 2 illustrates a schematic block diagram of example circuitry embodying a device that may perform various operations in accordance with some example embodiments described herein.

FIG. 3 illustrates an example flowchart for marking virtual identities across virtual spaces, in accordance with some example embodiments described herein.

FIG. 4 illustrates an example flowchart for verifying identity activity, in accordance with some example embodiments described herein.

FIG. 5 illustrates an example virtual object appended on virtual identities, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server. A server module (e.g., server application) may be a full function server module, or a light or secondary server module (e.g., light or secondary server application) that is configured to provide synchronization services among the dynamic databases on computing devices. A light server or secondary server may be a slimmed-down version of server type functionality that can be implemented on a computing device, such as a smart phone, thereby enabling it to function as an Internet server (e.g., an enterprise e-mail server) only to the extent necessary to provide the functionality described herein.

### Overview

As noted above, methods, apparatuses, systems, and computer program products are described herein tag (e.g., link) an individual's virtual identity (or identities) with a marker. Traditionally, the anonymity provided by virtual spaces (e.g., through providing means for anonymized access using aliases, pseudonyms, etc.) prevents and/or makes it difficult (and near impossible) to determine an association between virtual identities and a physical individual. Said another way, unless a virtual identity is provided with some form of identification, it is almost impossible to tell who owns the virtual identity. As discussed above, such difficulties present challenges, concerns, and restrictions (e.g., network security concerns, fraud concerns, etc.) for those interacting with others within virtual spaces.

To overcome the restrictions discussed above, in some embodiments, a marker may be established (e.g., generated) for an individual. The marker may include the individual's identification information. The marker may then be linked with all (or some) of the individual's virtual identities. For example, an individual may be a client (e.g., customer) of a bank. The bank, using one or more of the individual's identification information, generates a marker for the individual. The individual may then link the marker with one or more virtual identities (e.g., a digital avatar). As a result, the bank will now be able to identify any virtual identities marked with the marker as belonging to the individual.

In some embodiments, once the marker is linked a virtual identity, that virtual identity's activities (e.g., transactions) may be verified using the marker. Continuing with the above example where a bank's client tags a virtual identity with client marker. The bank may use the marker to confirm that the client is the actual person executing one or more transactions.

In some embodiments, the marker may be generated using identity information of the individual. More specifically, an individual's primary identification (ID) (e.g., driver license number, credit card number, social security number, biometrics, contact information, etc.) (also referred to herein as “first identity information”) may first be obtained. A secondary identification (ID) may then be generated using the primary ID (e.g., through hashing, randomization, and/or obfuscation of the primary ID). This secondary ID may then be included within the data of the marker (e.g., the secondary ID may be transformed into binary numbers and included within binary data making up the marker). Alternatively, this secondary ID may be included as graphics on the marker (e.g., a virtual object).

In some embodiments, the secondary ID may be dynamic. More specifically, a new secondary ID may be generated for each new virtual session initiated by the individual. For example, the bank's client logs into a first virtual space (e.g., the metaverse). At log-in, a first instance of the secondary ID is generated for the client to use with the marker. When the client logs out, the first instance of the secondary ID expires (e.g., becomes invalid). When the client subsequently logs back in to the first virtual space, a second instance of the secondary ID different from the first instance is generated for this subsequent session. Said another way, a temporary secondary ID may be generated for each session.

In some embodiments, a single marker may be linked to multiple virtual identities belonging to a same individual. Alternatively, unique ones of the marker may be generated for each of the individual's multiple virtual identities.

Although a high-level explanation of the operations of example embodiments has been provided above, specific details regarding the configuration of such example embodiments are provided below.

### System Architecture

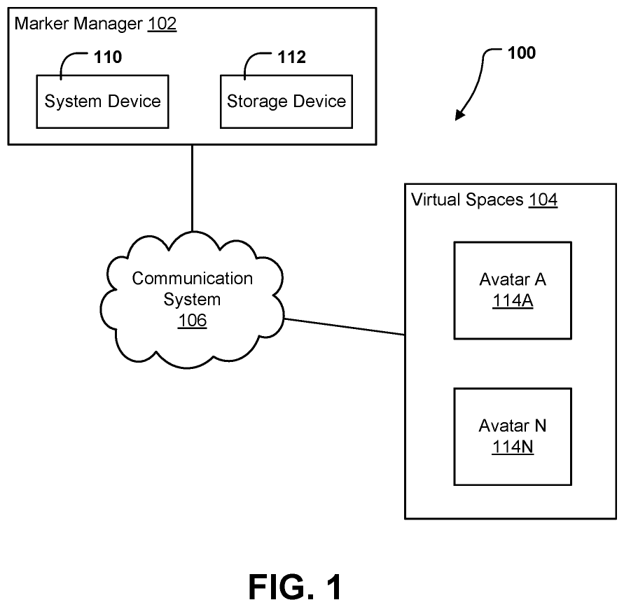

Example embodiments described herein may be implemented using any of a variety of computing devices or servers. To this end, FIG. 1 illustrates an example environment 100 within which various embodiments may operate. As illustrated, a marker manager 102 may include a system device 110 in communication with a storage device 112. Although system device 110 and storage device 112 are described in singular form, some embodiments may utilize more than one system device 110 and/or more than one storage device 112. Additionally, some embodiments of the marker manager 102 may not require a storage device 112 at all. Whatever the implementation, the marker manager 102, and its constituent system device(s) 110 and/or storage device(s) 112 may receive and/or transmit information via communication system 106 (e.g., the Internet) with any number of other devices, such as devices executing one or more virtual spaces 104 hosting one or more digital avatars 114A-114N.

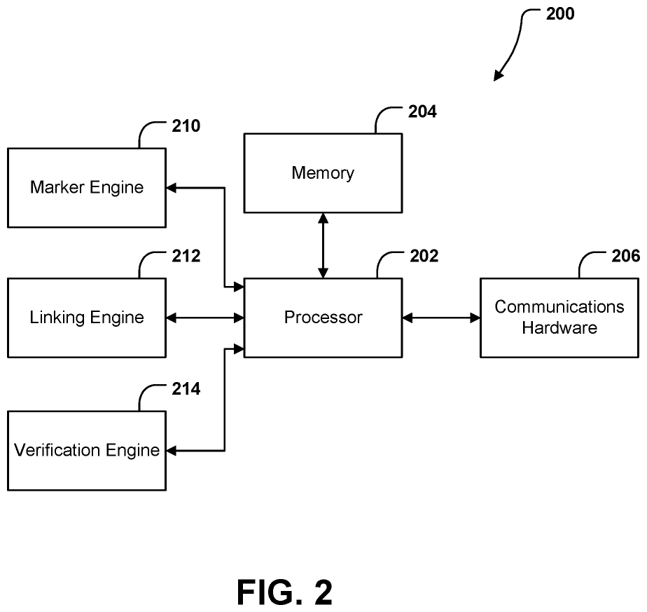

System device 110 may be implemented as one or more servers, which may or may not be physically proximate to other components of marker manager 102. Furthermore, some components of system device 110 may be physically proximate to the other components of marker manager 102 while other components are not. System device 110 may receive, process, generate, and transmit data, signals, and electronic information to facilitate the operations of the marker manager 102. Components of system device 110 are described in greater detail below with reference to apparatus 200 in connection with FIG. 2.

Storage device 112 may comprise a distinct component from system device 110 or may comprise an element of system device 110 (e.g., memory 204, as described below in connection with FIG. 2). Storage device 112 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communication system 106). Storage device 112 may host the software executed to operate the marker manager 102. Storage device 112 may store information relied upon during operation of the marker manager 102, such as various databases that may be used by the marker manager 102, data and documents to be analyzed using the marker manager 102, or the like. In addition, storage device 112 may store control signals, device characteristics, and access credentials enabling interaction between the marker manager 102 and one or more of digital avatar 114A-114N of virtual spaces 104.

The virtual spaces 104 may be a space created within a virtual environment (e.g., the metaverse, a website, an online video game, etc.). The virtual spaces 104 may each store one or more digital avatars 114A-114N created by one or more individuals. For example, assume that the virtual space is an online video game. Users of the online video game may each create one or more digital avatars 114A-114N (e.g., representing virtual identities of the users) within the online video game environment. These digital avatars 114A-114N are stored by computing devices (e.g., servers) hosting the online video game.

Although FIG. 1 illustrates an environment 100 and implementation in which the marker manager 102 interacts with the virtual spaces 104 to mark (via linking a marker) one or more of the digital avatars 114A-114N. In some embodiments users may directly interact with the marker manager 102 (e.g., via input/output circuitry of system device 110). Alternatively, users may indirectly interact with the marker manager 102 using any separate computing devices (not shown) that are connected to the marker manager 102 via the communication system 106. Whether by way of direct interaction or via separate computing devices, a user may communicate with, operate, control, modify, or otherwise interact with the marker manager 102 to perform the various functions and achieve the various benefits described herein.

### Example Implementing Apparatuses

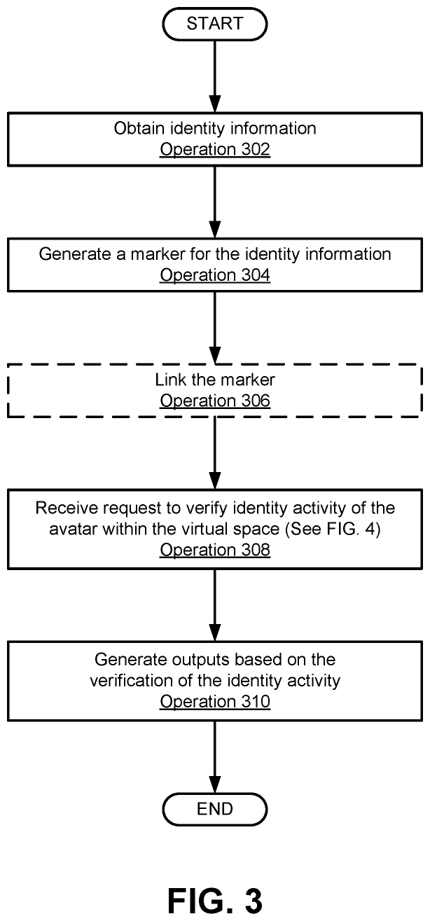

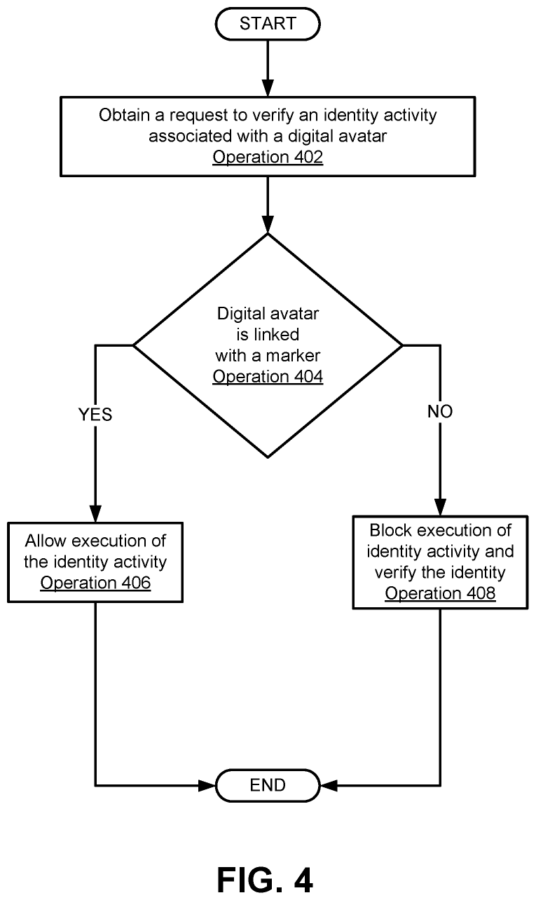

System device 110 of the marker manager 102 (described previously with reference to FIG. 1) may be embodied by one or more computing devices or servers, shown as apparatus 200 in FIG. 2. As illustrated in FIG. 2, the apparatus 200 may include processor 202, memory 204, communications hardware 206, input-output circuitry of communications hardware 206, marker engine 210, linking engine 212, and verification engine 214, each of which will be described in greater detail below. While the various components are only illustrated in FIG. 2 as being connected with processor 202, it will be understood that the apparatus 200 may further comprises a bus (e.g., a message bus, a messaging bus, a computer databus, etc.) (not expressly shown in FIG. 2) for passing information amongst any combination of the various components of the apparatus 200. The apparatus 200 may be configured to execute various operations described above in connection with FIG. 1 and below in connection with FIGS. 3-4.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor (e.g., software instructions stored on a separate storage device 112, as illustrated in FIG. 1). In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processor for causing transmission of such signals to a network or for handling receipt of signals received from a network. In some embodiments, the communications hardware 206 may include, for example, interfaces such as one or more ports (e.g., a laser port, a fiber-optic cable port, and/or the like) for enabling communications with other devices.

The communications hardware 206 may include input-output circuitry (not shown) configured to provide output to a user and, in some embodiments, to receive an indication of user input. It will be noted that some embodiments will not include input-output circuitry, in which case user input may be received via a separate device such as a separate client device or the like. The input-output circuitry of the communications hardware 206 may comprise a user interface, such as a display, and may further comprise the components that govern use of the user interface, such as a web browser, mobile application, dedicated client device, or the like. In some embodiments, the input-output circuitry may include a keyboard, a mouse, a touch screen, touch areas, soft keys, a microphone, a speaker, and/or other input/output mechanisms. The input-output circuitry may utilize the processor 202 to control one or more functions of one or more of these user interface elements through software instructions (e.g., application software and/or system software, such as firmware) stored on a memory (e.g., memory 204) accessible to the processor 202.

The marker engine 210 may be any means such as a device or circuitry embodied in either hardware or a combination of hardware and software that is configured to generate a marker using identity information (e.g., the first identity information discussed above) associated with an individual. The marker engine 210 may utilize processor 202, memory 204, or any other hardware component included in the apparatus 200 to perform these operations, as described in connection with FIGS. 3-4 below. The marker engine 210 may further utilize communications hardware 206 to gather data from a variety of sources (e.g., an individual associated with the data). More specifically, for example, the marker engine 210 may utilize input-output circuitry of communications hardware 206 to receive identity information and generate a marker using the identity information.

In addition, the apparatus 200 further comprises a linking engine 212 configured to link the marker to the one or more virtual identities (e.g., mark the one or more virtual identities with the marker). Prior to linking, each of these virtual identities lacks linking information to associate these virtual identities to the individual and/or one another. The linking engine 212 may utilize processor 202, memory 204, or any other hardware component included in the apparatus 200 to perform these operations, as described in connection with FIGS. 3-4 below. The linking engine 212 may further utilize communications hardware 206 to gather data from a variety of sources (e.g., avatar 114A through avatar 114N of virtual spaces 104 or storage device 112, as shown in FIG. 1), may utilize input-output circuitry of communications hardware 206 to receive data from a user, and in some embodiments may utilize processor 202 and/or memory 204 to link the one or more virtual identities to the marker.

Finally, the apparatus 200 further comprises a verification engine 214 configured to verify identity activity of the one or more virtual identities and generate an output based on the verification. The verification engine 214 may also be configured to generate an output specifying a result of the verification of the identity activity. The verification engine 214 may utilize processor 202, memory 204, or any other hardware component included in the apparatus 200 to perform these operations, as described in connection with FIGS. 3-4 below. The verification engine 214 may further utilize communications hardware 206 to gather data from a variety of sources (e.g., avatar 114A through avatar 114N of virtual spaces 104 or storage device 112, as shown in FIG. 1), may utilize input-output circuitry of communications hardware 206 to receive data from a user, and in some embodiments may utilize processor 202 and/or memory 204 to verify identity activity and generate an output based on the verification.

Although components 202-214 are described in part using functional language, it will be understood that the particular implementations necessarily include the use of particular hardware. It should also be understood that certain of these components 202-214 may include similar or common hardware. For example, the marker engine 210, linking engine 212 and verification engine 214 may each at times leverage use of the processor 202, memory 204, communications hardware 206, or input-output circuitry of communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry,” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the marker engine 210, linking engine 212 and verification engine 214 may leverage processor 202, memory 204, communications hardware 206, or input-output circuitry of communications hardware 206 as described above, it will be understood that any of these elements of apparatus 200 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or memory 204, communications hardware 206 or input-output circuitry of communications hardware 206 for enabling any functions not performed by special-purpose hardware elements. In all embodiments, however, it will be understood that the marker engine 210, linking engine 212 and verification engine 214 are implemented via particular machinery designed for performing the functions described herein in connection with such elements of apparatus 200.

In some embodiments, various components of the apparatuses 200 may be hosted remotely (e.g., by one or more cloud servers) and thus need not physically reside on the corresponding apparatus 200. Thus, some or all the functionality described herein may be provided by third party circuitry. For example, a given apparatus 200 may access one or more third party circuitries via any sort of networked connection that facilitates transmission of data and electronic information between the apparatus 200 and the third-party circuitries. In turn, that apparatus 200 may be in remote communication with one or more of the other components describe above as comprising the apparatus 200.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of flowcharts.

### Example Operations

Turning to FIGS. 3 and 4, example flowcharts are illustrated that contain example operations implemented by example embodiments described herein. The operations illustrated in FIGS. 3 and 4 may, for example, be performed by system device 110 of the marker manager 102 shown in FIG. 1 which may in turn be embodied by an apparatus 200, which is shown and described in connection with FIG. 2. To perform the operations described below, the apparatus 200 may utilize one or more of processor 202, memory 204, communications hardware 206, input-output circuitry of communications hardware 206, marker engine 210, linking engine 212, verification engine 214, and/or any combination thereof. It will be understood that user interaction with the marker manager 102 may occur directly via input-output circuitry of communications hardware 206, or may instead be facilitated by a separate entity, not expressly shown in FIG. 1, and which may have similar or equivalent physical componentry facilitating such user interaction.

Turning first to FIG. 3, example operations are shown for generating a marker, associated to an individual, and using the marker to link the individual with one or more virtual identities of the individual.

As shown by operation 302, the apparatus 200 includes means, such as communications hardware 206, or the like, for obtaining identity information of an individual. The identity information may be first identity information including, but not limited to: a driver license number; a credit card number; a social security number; one or more biometrics, contact information, etc. In some embodiments, the identity information may also include one or more virtual identities of the individual. Each of the individual's virtual identities may be embodied by one or more of: (i) a digital avatar, (ii) a profile image, (iii) an email address, (iv) a username, and/or any other unique identifier used to identify the user within one or more virtual spaces.

In some embodiments, the identity information may be obtained through self-reporting by the individual (e.g., using one or more of the input-output circuitry of the communications hardware 206). Alternatively, the identity information may be input (via the input-output circuitry of the communications hardware 206) by a third-party receiving the identity information from the individual. Once received by the communications hardware 206, the communications hardware 206 provides the identity information to a marker engine 210

For example, assume that the individual is a client of a bank. The individual may go to a physical location of the bank to report and/or enter (via a terminal at the bank linked to the marker manager 102) the identity information. If reported, the identity information will be entered (via the terminal at the bank) by an employee of the bank. The biometrics information of the individual may also be obtained at the physical location and provided to the marker manager 102 via the terminal.

Additionally, if the client is a new customer of the bank, the bank may also generate an account number and/or a unique client number to be included in the client's identity information. Because this unique customer number is generated by the bank, the bank is advantageously the only entity (beside perhaps the individual if the individual were informed of this unique customer number) that knows this unique customer number. As a result, if this unique customer number is stored in an air-gapped computing device within the bank, then it would be difficult for malicious third-party actors to steal this unique customer number.

As shown by operation 304, the apparatus 200 includes means, such as marker engine 210, or the like, for generating a marker for an individual using the identity information (e.g., the identity information obtained at operation 302). The marker may be a string of characters, numbers, and symbols. The marker may also be embodied by: (i) a non-fungible token (NFTs), (ii) a graphic (e.g., a virtual object that can be appended to a digital avatar), (iii) a quick response (QR) code, or the like. Once generated, the marker engine 210 may store the marker in a database of the marker manager 102 (e.g., storage device 112).

In some embodiments, the marker may include a secondary ID. The secondary ID may be generated using the first individual information included in the identity information obtained in operation 302. More specifically, one or more of the first individual information may be transformed (e.g., hashed, randomized, and/or obfuscated, etc.) into the secondary ID. Once generated, the secondary ID may be included within the data of the marker (e.g., the secondary ID may be transformed into binary numbers and included within binary data making up the marker). Alternatively, the secondary ID may be included as graphics on the marker (e.g., as a string of characters, numbers, and/or symbols on a virtual object).

Continuing with the above example discussed in operation 302, the secondary ID may be generated using a unique customer number of the client (e.g., WELLSF20350469). For example, after the transformation, the secondary ID may become a string of characters, numbers, and symbols such as: C561AC91083335DCD087E1C93A68F844C17D06323B5A5DD4CA2175676575E149. This string may then be transformed into binary numbers and embedded into data making up a virtual object such as a medallion to be worn or appended to a digital avatar of the client.

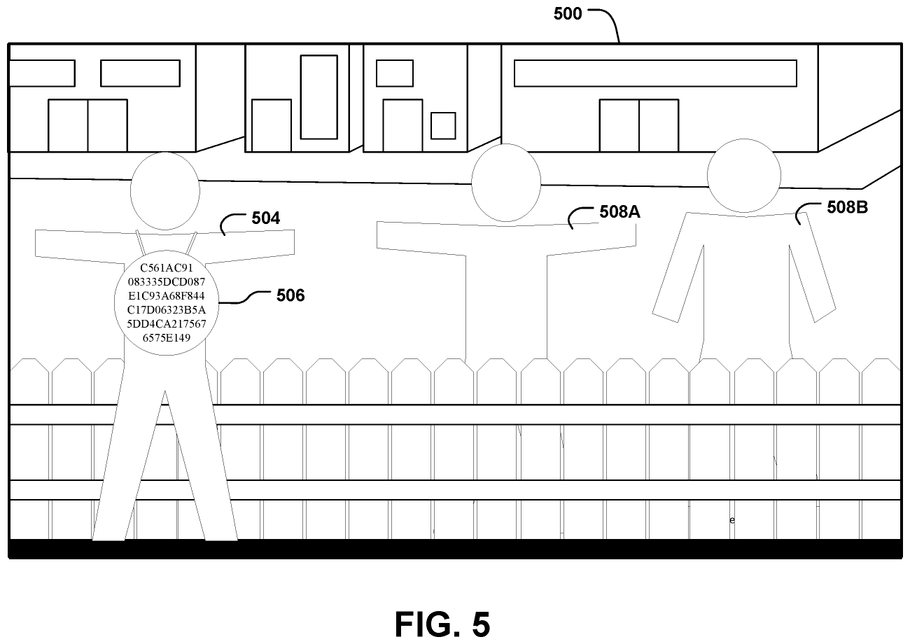

Alternatively, the string may be displayed on a surface of the medallion. This is shown below in reference to FIG. 5.

In some embodiments, the secondary ID may be static. Alternatively, the secondary ID may be dynamic. More specifically, a new secondary ID may be generated each time a user starts a virtual session (e.g., logs into a virtual space, logs onto a website, etc.). When the virtual session expires (e.g., times out, the user logs off, etc.), the secondary ID also expires, and another new secondary ID is generated for a subsequent session. Having the secondary ID be dynamic advantageously provides an additional layer of security. In particular, the dynamic secondary ID prevents others (e.g., malicious third-party actors) from copying (e.g., stealing) the individual's secondary ID to be used during other sessions (or in other virtual spaces).

As shown by operation 306 (marked with broken lines in FIG. 3 to indicate that this operation may be optional, discussed further below), the apparatus 200 includes means, such as linking engine 212, or the like, for linking the marker to the one or more virtual identities of the individual. Said another way, the individual's virtual identities are marked with the marker. As discussed above, the marker may be a virtual object appended to the individual's digital avatar(s). The marker may also be a string of characters, numbers, and/or symbols that may be included within a profile associated with the user's virtual identity.

In some embodiments, the string may also be included in transaction data of a transaction being executed by the individual. For example, continuing with the above-discussed example in operations 302 and 304, a transaction page may allow (e.g., permit) the individual to upload data (e.g., pictures, documents, etc.) and/or include notes/comments to be included within the transaction data. The string may be stored in any of the uploaded data and or included in the note/comments section. When the transaction is executed and the bank receives the transaction data, the bank may verify the individual using the included string.

In some embodiments, the marker may be linked to the individual's virtual identity by the bank using the linking engine 212. For example, continuing with the above-discussed example in operations 302 and 304, if the bank is aware of one or more of the individual's virtual identities, the bank may use the linking engine 212 to link the generated marker(s) to these known virtual identities. Alternatively, the marker may be linked to an individual's virtual identity directly by the individual. For example, the individual may be provided with the marker upon request by the individual to the marker manager 102. The request may be transmitted through a portal (e.g., the bank's online banking platform) to the marker manager 102. Once the individual receives the marker via the portal, the individual may append the marker to the individual's digital avatar.

As shown by operation 308, the apparatus 200 includes means, such as verification engine 214, or the like, for using the marker linked to the one or more virtual identities to verify identity activity (to be discussed further below with respect to FIG. 4) of these virtual identities within virtual spaces.

More specifically, turning to FIG. 4, example operations are shown for using the marker to verify an individual's identity activity within virtual spaces.

As shown by operation 402, the apparatus 200 includes means, such as communication hardware 206, verification engine 214, or the like, for obtaining a request to verify identity activity associated with a digital avatar (e.g., representing one of the individual's one or more virtual identities). The request may be instantiated as actions are taken by the digital avatar in a virtual space. The request may comprise the identity activity, information on the digital avatar, and the marker appended to the digital avatar (if one is appended).

For example, continuing with the above-discussed example in operations 302-306, assume that the client has appended the marker (e.g., in the form of a medallion) to a digital avatar and is using the digital avatar to buy an item from another digital avatar belonging to another individual. Further assume that the transaction will be using a credit card number (e.g., one of the first identity information) of the individual. The execution of said transaction may trigger a verification request (e.g., from the metaverse to a payment schema, and perhaps ultimately to the bank if the payment schema is not operated by the bank) by the bank to verify that the digital avatar using the credit card number is indeed associated with (e.g., owned and/or controlled by) the individual.

As shown by operation 404, the apparatus 200 includes means, such as verification engine 214, or the like, for making a determination regarding whether the digital avatar identified in operation 402 is associated with the individual whose first identity information is included in the identity activity.

For example, continuing with the above-discussed example in operations 302-306, the determination may be performed to check whether the digital avatar making the transaction is linked to the marker (e.g., is marked with the marker). As one example, a screenshot of the digital avatar may be taken, and one or more machine learning techniques may be used to identify the marker (namely, the secondary ID displayed on the marker) within the screenshot. As another example, the data included in the marker (e.g., the binary data) may be extracted from the virtual space and parsed to look for the binary form of the secondary ID included in the marker.

As an additional layer of security, the maker may also be associated with one or more biometrics (e.g., fingerprint, voice print, facial features, etc.) of the individual. When the transaction is being verified by the verification engine 214, the verification engine 214 will request the individual to whom the digital avatar belongs to provide, in addition to verifying the marker, one or more biometrics (via biometrics hardware such as a fingerprint scanner or a microphone connected as input-output circuitry of the communications hardware 206).

In response to the verification engine 214 verifying the identity of the digital avatar executing the transaction (i.e., YES in operation 404), the method may proceed to operation 406. In particular, as shown by operation 406, the apparatus 200 includes means, such as verification engine 212, or the like, for allowing (e.g., permitting) execution of the transaction of the verified digital avatar.

Alternatively, in response to the verification engine 214 being unable to verify the identity of the digital avatar (i.e., NO in operation 404), the method may proceed to operation 408. In particular, as shown by operation 408, the apparatus 200 includes means, such as verification engine 214, or the like, for blocking execution of the transaction of the verified digital avatar.

For example, continuing with the above-discussed example in operations 302-306, another digital avatar (in the same or a different virtual space as the digital avatar identified in operation 402) may be executing a transaction using first identity information (e.g., payment card information) of the client. However, this digital avatar is not marked by the marker (e.g., is not linked to the marker), and cannot be verified by the verification engine 214. As a result, transactions by this digital avatar will first be blocked, and additional verification may be required before the transaction may be re-attempted.

Returning to FIG. 3, as shown by operation 310, the apparatus 200 includes means, such as communications hardware 206, verification engine 214, or the like, for generating outputs (e.g., a graphical user interface (GUI), a pop-up window, etc.) based on the result of the verification in operation 404. More specifically, the verification engine 214 may generate an output including the results of operation 406 (i.e., the allowing of the transaction) or the results of operation 408 (i.e., the blocking of the transaction and the requiring of further verification). The verification engine 214 may then provide the generated output to the communications hardware 206 such that the output is transmitted (by the communications hardware 206) to the above-discussed computing device(s) processing the transaction by the digital avatar.

As described above, example embodiments provide methods and apparatuses that enable improved verification of an individual's virtual identities. Example embodiments thus provide tools that overcome the problems and restrictions associated with tracing an individual within virtual spaces, while also advantageously being able add additional layers of security to prevent theft of the individual's virtual identities and/or the individual's sensitive information (e.g., payment card numbers).

As these examples all illustrate, example embodiments contemplated herein provide technical solutions that solve real-world problems faced during the existence of various identities in various virtual spaces. And while tracing a physical individual within the virtual realm has been an issue, the recently exploding amount of functions (e.g., anonymity afforded in decentralized networks) made available by recently emerging technology (e.g., the metaverse) today has made this problem significantly more acute, as the demand for identity tracing and transparency to verify actions by individuals in the virtual spaces has grown significantly. Example embodiments described herein thus represent a technical solution to these real-world problems of activities in such virtual spaces.

FIGS. 3 and 4 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

### Example Virtual Object Appended on Virtual Identities

Turning to FIG. 5, FIG. 5 is a diagram illustrating an example appended virtual object. Environment 500 represents an example virtual space (e.g., the metaverse) that is hosted on a publicly accessible server.

In this example, a digital avatar 504, created by a client of a bank (e.g., the client in the example discussed in FIGS. 3-4), visits a neighborhood owned by other entities (denoted by digital avatars 508A and 508B) in the metaverse. The digital avatar 504 decides to buy a house in the neighborhood and initiates a transaction with the other digital avatars 508A and 508B using payment information associated with the client. During the transaction, the virtual object 506 (e.g., a medallion worn by the avatar 504) is verified to confirm that digital avatar 504 belongs to the client whose payment information is being used for the transaction (via confirming that the virtual object 506 includes the client's secondary ID of C561AC91083335DCD087E1C93A68F844C17D06323B5A5DD4CA2175676575E149. The transaction is allowed (e.g., permitted) go through and digital avatar 504 now owns a house in environment 500.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for marking virtual identities, the method comprising:
obtaining, by communications hardware of a marker manager, first identity information of a first individual;
generating, by a marker engine of the marker manager, a first marker based on the first identity information;
linking, by a linking engine, the first marker to multiple virtual identities of the first individual;
receiving, by the communications hardware, a first request to verify first identity activity associated with a first virtual identity within a virtual space, wherein the first identity activity comprises the first identity information of the first individual;
extracting, by a verification engine of the marker manager, the first marker associated with the first virtual identity from the virtual space;
making, by the verification engine of the marker manager, a first determination that a link exists between the first virtual identity and the first marker;
permitting, by the verification engine, execution of the first identity activity based on the first determination; and
generating, by the verification engine, a first output specifying that the execution of the first identity activity is permitted.

2. The method of claim 1, further comprising:
receiving, by the communications hardware, a second request to verify second identity activity associated with a second virtual identity within the virtual space, wherein the second identity activity comprises the first identity information of the first individual, and wherein information associated with the second virtual identity is not included in the first identity information;
making, by the verification engine, a second determination that the second virtual identity is not linked to the first marker;
blocking, by the verification engine, execution of the second identity activity based on the second determination; and
generating, by the verification engine, a second output specifying that the execution of the second identity activity is blocked.

3. The method of claim 1, further comprising:
obtaining, by the communications hardware, second identity information of a second individual different from the first individual;
generating, by the marker engine, a second marker based on the second identity information;
linking, by the linking engine of the marker manager, the second marker to a second virtual identity of the second individual, wherein the second virtual identity is included in the second identity information;
receiving, by the communications hardware, a second request to verify second identity activity within the virtual space, wherein the second identity activity comprises the second identity information of the second individual;
making, by the verification engine, a second determination that the second virtual identity is linked to the second marker;
permitting, by the verification engine, execution of the second identity activity based on the second determination; and
generating, by the verification engine, a second output specifying that the execution of the second identity activity is permitted.

4. The method of claim 3, wherein linking the second marker to the second virtual identity of the second individual further comprises:
receiving, by the communications hardware, a linking request to link the second marker to the second virtual identity, wherein the second marker is linked to the second virtual identity in response to the linking request.

5. The method of claim 1, wherein the first marker comprises a temporary secondary identification (ID) of the first individual.

6. The method of claim 5, wherein the temporary secondary ID in the first marker expires after a session of the first virtual identity in the virtual space is terminated, and the temporary secondary ID is based on the first identity information of the first individual.

7. The method of claim 1, wherein the first virtual identity is a digital avatar of the first individual in the virtual space and the first marker is a virtual object appended on the digital avatar of the first individual.

8. The method of claim 1, wherein the first identity information comprises at least one of a payment card of the first individual, biometrics information of the first individual, and contact information of the first individual.

9. (canceled)

10. The method of claim 1, wherein each of the multiple virtual identities of the first individual are located in different virtual spaces including the virtual space.

11. An apparatus for marking virtual identities, the apparatus comprising:
communications hardware configured to obtain first identity information of a first individual;
a marker engine configured to generate a first marker based on the first identity information;
a linking engine configured to link the first marker to multiple virtual identities of the first individual,
wherein the communications hardware is further configured to receive a first request to verify first identity activity associated with a first virtual identity within a virtual space, wherein the first identity activity comprises the first identity information of the first individual, and wherein information associated with the first virtual identity is not included in the first identity information; and
a verification engine configured to:
extract the first marker associated with the first virtual identity from the virtual space,
make a first determination that a link exists between the first virtual identity and the first marker,
permit execution of the first identity activity based on the first determination, and
generate a first output specifying that the execution of the first identity activity is permitted.

12. The apparatus of claim 11,
wherein the communications hardware is further configured to receive a second request to verify second identity activity associated with a second virtual identity within the virtual space,
wherein the second identity activity comprises the first identity information of the first individual,
wherein information associated with the second virtual identity is not included in the first identity information, and
wherein the verification engine further configured to:
make a second determination that the second virtual identity is not linked to the first marker,
block execution of the second identity activity based on the second determination, and
generate a second output specifying that the execution of the second identity activity is blocked.

13. The apparatus of claim 11,
wherein the communications hardware is further configured to obtain second identity information of a second individual different from the first individual,
wherein the marker engine is further configured to obtain the second identity information of the second individual different from the first individual,
wherein the linking engine is further configured to link a second marker to a second virtual identity of the second individual,
wherein the second virtual identity is included in the second identity information,
wherein the communications hardware is further configured to receive a second request to verify second identity activity within the virtual space, wherein the second identity activity comprises the second identity information of the second individual, and
wherein the verification engine is further configured to:
make a second determination that the second virtual identity is linked to the second marker,
permit execution of the second identity activity based on the second determination, and
generate a second output specifying that the execution of the second identity activity is permitted.

14. The apparatus of claim 13, wherein linking the second marker to the second virtual identity of the second individual further comprises, by the communications hardware:
receiving a linking request to link the second marker to the second virtual identity, wherein the second marker is linked to the second virtual identity in response to the linking request.

15. The apparatus of claim 11, wherein the first marker comprises a temporary secondary identification (ID) of the first individual.

16. A computer program product for marking virtual identities, the computer program product comprising at least one non-transitory computer-readable storage medium storing software instructions that, when executed, cause an apparatus to:
obtain first identity information of a first individual;
generate a first marker on the first identity information;
link the first marker to multiple virtual identities of the first individual;
receive a first request to verify first identity activity associated with a first virtual identity within a virtual space, wherein the first identity activity comprises the first identity information of the first individual;
extract the first marker associated with the first virtual identity from the virtual space;
make a first determination that a link exists between the first virtual identity and the first marker;
permit execution of the first identity activity based on the first determination; and
generate a first output specifying that the execution of the first identity activity is permitted.

17. (canceled)

18. The computer program product of claim 16, wherein the apparatus is further caused to:
obtain second identity information of a second individual different from the first individual;
generate a second marker based on the second identity information;
link, by a linking engine of a marker manager, the second marker to a second virtual identity of the second individual, wherein the second virtual identity is included in the second identity information;
receive a second request to verify second identity activity within the virtual space, wherein the second identity activity comprises the second identity information of the second individual;
make a second determination that the second virtual identity is linked to the second marker;
permit execution of the second identity activity based on the second determination; and
generate a second output specifying that the execution of the second identity activity is permitted.

19. The computer program product of claim 18, wherein linking the second marker to the second virtual identity of the second individual further comprises:
receiving a linking request to link the second marker to the second virtual identity, wherein the second marker is linked to the second virtual identity in response to the linking request.

20. The computer program product of claim 16, wherein the first marker comprises a temporary secondary identification (ID) of the first individual.

21. The method of claim 1, further comprising capturing, by the verification engine, a screenshot of the first virtual identity with an appended virtual object in the virtual space, wherein the first marker is extracted from the appended virtual object depicted in the screenshot.

22. The apparatus of claim 11, wherein the verification engine is further configured to capture, a screenshot of the first virtual identity with an appended virtual object in the virtual space, wherein the first marker is extracted from the appended virtual object depicted in the screenshot.
